(19) United States
(12) Patent Application Publication
(10) Pub. No.: US 2022/0279801 A1
(43) Pub. Date: Sep. 8, 2022

(54) CRUNCHY SNACK FOOD PRODUCT

(71) Applicant: SOCIETE DES PRODUITS NESTLE S.A., Vevey (CH)

(72) Inventors: ADAM BURBIDGE, Arzier (CH); SOCRATES FOSCHINI, Zurich (CH); MARTIN LESER, Bretigny-sur-Morrens (CH); MARTIN MICHEL, Lausanne (CH); JUDITH WEMMER, Zurich (CH); ERICH JOSEF WINDHAB, Hemishofen (CH)

(21) Appl. No.: 17/636,508

(22) PCT Filed: Aug. 20, 2020
(86) PCT No.: PCT/EP2020/073319

§ 371 Date: Feb. 18, 2022

(30) Foreign Application Priority Data
Aug. 21, 2019 (EP) 19192939.7

(51) Int. Cl. A21D 13/062; A21D 2/18; A21D 2/26; A21D 8/02; A21D 13/068; A21D 13/064

(52) U.S. Cl. CPC A21D 13/062; A21D 2/188; A21D 2/262; A21D 2/263; A21D 2/266; A21D 8/025; A21D 13/068; A21D 13/064

(57) ABSTRACT

The present invention relates to crunchy edible formulations comprising fibre, protein and a restricted amount of carbohydrate and substantially devoid of fat and sugar. Methods of making said formulations and their use in food products are also provided.

### BACKGROUND

Snacking is a global mega product category. According to 2018 data from Euromonitor International, the annual sales of snacking products is 380 Billion USD.

Many of today's snacks have a crunchy texture. Crunchiness (or crispiness, crumbliness) is a much appreciated sensory property in a variety of different products. ‘Crunchy’ is amongst the fastest growing texture claims. Between 2012 and 2017 crunchy product sales have seen a growth of circa 70%.

Examples of products are snacks, bars, muesli, crunchy inclusions in oil based peanut butter, spreads, creams, chips, apéro sticks, crackers, pretzels, cookies, or others.

The main technology used to create crunchy perception is based on adding flour (i.e., starch) and/or sugar in relatively high amounts (50% or more in a typical recipe) and subsequent baking/drying or cooking. The fibre and/or protein content, i.e., the amount of health promoting or health sustaining ingredients is therefore remarkably low in these products.

By increasing the consumption of such starchy and sugary products, the risk to exceed recommended intake of sugars and refined grains as well as various health problems also increases.

These are major drawbacks, and necessitate the development of new more healthy concepts without compromising on crunchy texture.

### SUMMARY OF THE INVENTION

The method of the present invention allows the creation of a crunchy textured edible formulation without adding sugar and starchy materials.

The invention relates in general to a method of making an edible formulation, said method comprising the steps of preparing a mixture comprising fibre, protein, carbohydrate, and wherein the mixture is devoid of fat; foaming the mixture; and heating the foamed mixture.

The invention further relates to a method of making an edible formulation, said method comprising the steps of preparing a mixture comprising fibre, protein, carbohydrate, and wherein the mixture is devoid of sugar; foaming the mixture; and heating the foamed mixture.

The invention further relates to a method of making an edible formulation, said method comprising the steps of preparing a mixture comprising fibre, protein, carbohydrate, and a liquid, and wherein the mixture is devoid of fat and sugar; foaming the mixture; and heating the foamed mixture.

The invention further relates to a method of making an edible formulation, said method comprising the steps:

a. Preparing a mixture comprising fibre, protein, carbohydrate, and a liquid, and wherein the mixture is devoid of fat and sugar;

b. Foaming the mixture;

c. Optionally moulding into a shape; and

d. Heating and drying the foamed mixture.

The invention further relates to a dry foamed edible formulation, preferably obtained by a method as described herein.

The invention further relates to the use of a foamed edible formulation as described herein in a food product.

### EMBODIMENTS OF THE INVENTION

The present invention relates to a method of making an edible formulation, said method comprising the steps:

a. Preparing a mixture comprising fibre, protein, carbohydrate, and a liquid wherein carbohydrate is present at less than 20 wt %, and wherein the mixture is substantially devoid of fat and sugar;

b. Foaming the mixture;

c. Optionally moulding into a shape; and

d. Heating and drying the foamed mixture.

In some embodiments, the invention relates to a method of making an edible formulation, said method comprising the steps:

a. Preparing a mixture comprising fibre, protein, carbohydrate, and a liquid wherein carbohydrate is present at less than 20 wt %, wherein the mixture is substantially devoid of fat and sugar, and wherein the prepared mixture has a zero shear viscosity greater than 10 Pa·s;

b. Foaming the mixture to not less than 5 vol % gas fractions, preferably by extrusion;

c. Optionally moulding into a shape; and

d. Heating and drying the foamed mixture.

In some embodiments, the fibre comprises a non-soluble fibre component and a soluble fibre component.

In some embodiments, the non-soluble fibre is a cellulose fibre, preferably citrus fibre. In some embodiments, the non-soluble fibre is carrot fibre. In some embodiments, the non-soluble fibre is apple fibre. In some embodiments, the fibre is from grains and/or leguminoses.

In some embodiments, the average non-soluble fibre length is less than 100 μm.

In some embodiments, the mixture comprises up to 67 wt % protein.

In some embodiments, the protein is egg white protein.

In some embodiments, the mixture has a zero shear viscosity η₀ greater than 10 Pa·s.

In some embodiments, the mixture comprises 10-30 wt % solids. In some preferred embodiments, the mixture comprises 15-20 wt % solids. In some preferred embodiments, the mixture comprises about 18 wt % solids.

In some embodiments, the non-soluble fibre and protein are present in a ratio of between about 0.5:1 to about 1:0.5. In some embodiments, the non-soluble fibre and protein are present in a ratio of about 1:1. In some embodiments, the non-soluble fibre and protein are present in a ratio of about 1:0.5. In some embodiments, the non-soluble fibre and protein are present in a ratio of about 0.5:1.

In some embodiments, the protein is a globular protein.

In some embodiments, the mixture further comprises pectin, preferably sugar beet pectin.

In some embodiments, the mixture comprises 10-30 wt % non-soluble fibre, protein and pectin preferably in a weight ratio of about 1/1/0.38.

In some embodiments, the mixture is devoid of gluten. In some embodiments, the mixture is devoid of oil.

In some embodiments, the mixture is foamed by one or more of a) dissolving gas under pressure followed by pressure release, b) whipping, c) rotating membrane foaming or d) addition of blowing agents.

In some preferred embodiments, the mixture is foamed using an extrusion device.

In some embodiments, the gas is carbon dioxide, nitrogen, or air, preferably carbon dioxide.

In some embodiments, the foamed mixture is heated and dried with hot air and/or microwave power.

In some embodiments, the foamed mixture is heated and dried until the moisture content is less than 10 wt %.

In some embodiments, the edible formulation has a density of between 100 to 500 kg/m³, or between 100 to 300 kg/m³.

In some embodiments, the edible formulation is not subject to any additional coating step, for example wax coating.

The invention further relates to an edible formulation, obtained by a method as described herein.

The invention relates in general to a dry foamed edible formulation comprising non-soluble fibre, protein, carbohydrate, wherein carbohydrate is present at less than 20 wt % and wherein the mixture is substantially devoid of fat and sugar.

The invention further relates to a dry foamed edible formulation comprising non-soluble fibre, protein, carbohydrate, wherein carbohydrate is present at less than 20 wt % and wherein the mixture is substantially devoid of fat and sugar, and wherein the dry formulation shows more than one fracturing event indicated by more than one stress or force peak in mechanical testing such as needle or blade penetration.

In some embodiments, the dry formulation shows more than one fracturing event indicated by more than one stress or force peak in mechanical testing such as needle or blade penetration upon a penetration depth of 1 millimeter, preferably 0.2 millimeters.

In some embodiments, a water droplet placed on the surface of the formulation takes more than 10 minutes to be taken up by capillary forces.

In some embodiments, the fibre comprises a non-soluble component and a soluble fibre component.

In some embodiments, the non-soluble fibre and protein are present in a ratio of about 1:5 to 5:1, preferably 1:2 to 2:1.

In some embodiments, the protein is globular protein.

In some embodiments, the formulation further comprises soluble fibre.

In some embodiments, the formulation comprises non-soluble fibre, egg white protein and sugar beet pectin, wherein the non-soluble fibre is preferably citrus fibre.

In some embodiments, the citrus fibre, egg white protein and sugar beet pectin in are present in a weight ratio of about 1/1/0.38.

In some embodiments, fibre is present at about 58% of solids and protein is present at about 42% of solids. In some embodiments, citrus fibre is present at about 42% and sugar beet pectin is present at about 16%. In some embodiments, fat is present at about 0%.

In some embodiments, the formulation has a moisture content of less than 10 wt %.

In some embodiments, the formulation has a surface wettability expressed by a contact angle greater than 0°.

In some embodiments, the formulation has a density of between 100-500 kg/m³, or between 100 to 300 kg/m³

In some embodiments, the formulation is a vegetarian formulation.

The invention further relates to the use of a dry foamed edible formulation as described herein in a food product.

The invention further relates to a food product comprising a dry foamed edible formulation as described herein.

In some embodiments, the food product is a vegetarian food product.

### DETAILED DESCRIPTION OF THE INVENTION

### Definitions

The following definitions are provided for the technical features used throughout the specification.

Fibre (or dietary fibre) denotes carbohydrate polymers with 10 or more monomeric units, which are not hydrolysed by the endogenous enzymes in the small intestine of humans. Examples are non-starch plant polysaccharides, such as cellulose fibre, for example citrus fibre, hemicelluloses, pectin, β-glucans, mucilages and gums. The solubility of dietary fibre is determined by the relative stability of the ordered and disordered form of the polysaccharide. Molecules that fit together in a crystalline array are likely to be energetically more stable in solid state than in solution. Hence, linear polysaccharides, i.e., cellulose, tend to be insoluble (non-soluble), while branched polysaccharides or polysaccharides with side chains, such as pectin or modified cellulose, are more soluble. Hence, non-soluble fibre denotes fibre with low or no solubility in water. This might however contain residues of soluble fibre due to the production/extraction process. Soluble fibre denotes dietary fibre with high solubility such as pectin.

Starch denotes a polymeric carbohydrate consisting of a large number of glucose units joined by glycosidic bonds. Starch is a polysaccharide comprising glucose monomers joined in α 1,4 linkages. The simplest form of starch is the linear polymer amylose; amylopectin is the branched form. Starch is hydrolyzed by the endogenous enzymes in the small intestine of humans. It is the most common carbohydrate in human diets and is contained in large amounts in staple foods like potatoes, wheat, maize, rice, and cassava.

Crunchiness or crispiness denotes a formulation or food product showing at least one brittle fracturing event. Fracturing is accompanied by the emission of a sound. The transition from crispness to crunchiness involves an increase in stiffness and a decrease in number of fracture events. Crunchiness can be defined by needle (or thin cylinder) or blade penetration characteristics when exceeding a minimum of one fracture event while the needle or blade fully penetrates through the material, but at least by a penetration length of 1 millimeter, preferably 0.2 millimeters. A fracture event is represented by a force or stress peak followed by a sudden decrease in force or stress by minimum 5%.

Brittleness or brittle fracturing denotes fracturing upon exceeding the elastic deformation limit without undergoing plastic deformation.

Stiffness denotes the extent to which an object resists stress-induced in response to an applied force (https://en.wikipedia.org/wiki/Deformation_(mechanics)).

Dry denotes a moisture content of less than 10%.

Protein denotes plant and/or animal based bio-macromolecules, consisting of one or more long chains of amino acid residues. A protein is typically a polymer consisting of 50 or more amino acid residues linked by peptide bonds. Proteins are digested in the stomach and intestine by hydrochloric acid and endogenous enzymes. Proteins are an essential nutrient for the human body are contained in larger amounts in meat, milk, egg, legumes, seeds, and some grains like rice or oats.

Globular protein denotes a protein that can be denatured.

Edible fats and oils are lipid materials derived from animals or plants. Physically, oils (e.g. sunflower, canola) are liquid at room temperature, and fats (e.g. lard) are solid. Chemically, both fats and oils are composed of triglycerides. They are basically non-soluble in water.

Sugar is the generic name for sweet-tasting, soluble carbohydrates. The various types of sugar are derived from different sources. Simple sugars are called monosaccharides and include glucose (also known as dextrose), fructose, and galactose. “Table sugar” or “granulated sugar” refers to sucrose, a disaccharide of glucose and fructose. In the body, sucrose is hydrolyzed into fructose and glucose.

Paste-like viscosity denotes a zero shear viscosity η₀ larger than 10 Pa·s at 20° C.

Water uptake can be defined as the minimum time for at least 90% of a water drop of at least 15 microliters in volume on top of a flat formulation or product to be sucked into the structure. Preferably the minimum time is 10 minutes, preferably 100 minutes

Vegetarian edible formulations or vegetarian food products do not comprise any animal products, with the exception of egg products and dairy products.

When a composition is described herein in terms of wt %, this means a mixture of the ingredients on a dry basis, unless indicated otherwise.

The terms “comprising”, “comprises” and “comprised of” as used herein are synonymous with “including” or “includes”; or “containing” or “contains”, and are inclusive or open-ended and do not exclude additional, non-recited members, elements or steps. The terms “comprising”, “comprises” and “comprised of” also include the term “consisting of”.

As used herein the term “about” means approximately, in the region of, roughly, or around. When the term “about” is used in conjunction with a numerical value or range, it modifies that value or range by extending the boundaries above and below the numerical value(s) set forth. In general, the term “about” is used herein to modify (a) numerical value(s) above and below the stated value(s) by 10%.

Substantially devoid, as in substantially devoid of, for example, fat or sugar means an amount which is less than 5 wt %, preferably less than 4 wt %, preferably less than 3 wt %, preferably less than 2 wt %, preferably less than 1 wt %, or even completely absent (0 wt %).

Method of Making an Edible Formulation

Foaming of the mixture provides it with a lighter texture, crunchy/brittle breaking behavior when dried. It allows the tailoring of product density, which in turn leads to a more crispy, lighter texture at lower density and a more crunchy, harder texture at higher density. Furthermore, the pores introduced through foaming cause stopping and re-propagation of the fracture during biting. These are referred to as multiple fracture events. These are essential for the perception of crunchiness and crispiness. Foaming of the paste-like mixture is preferably achieved by extrusion foaming as it allows to homogeneously incorporate the desired amount of gas into a paste with a viscosity of 10 Pas or higher. This foaming process involves the addition of the formulation into the extruder, preferably a twin-screw extruder. The paste-like formulation is pressurized in the extruder to a pressure of 5 bar or above. Gas is injected and dissolved and/or dispersed under pressure and shear. The pressure release at the extruder exit results in bubble nucleation and foam formation. However, other foaming technologies can also be used to create the foam structure, for example using baking soda.

During drying, the most important part to control is the generation of a homogeneous drying temperature field, and avoiding heterogeneous drying. Controlled microwave drying and superposition of microwave and hot air drying is preferred. However, other drying technologies can also be used to create the desired pore structure, such as vacuum-microwave or infrared drying.

The heating and drying process causes heat-setting of the proteins and removal of water while maintaining the foam structure. The homogeneous temperature distribution throughout the product during drying allows for the generation of a dry porous solid with homogeneous pore structure providing multiple fracture events. Preferably, this is achieved by superposition of microwave and convection drying. The volumetric heating through microwave application causes steam generation in the foam bubbles resulting in expansion and thus counteracts drying-induced foam collapse. The applied microwave power and convection temperature tailors the extent of foam bubbles expansion. A low expansion is desired to create a dry porous solid with closed pores and a closed outer surface to such an extent that penetration of water into the structure and thus water-induced softening are decelerated. Heat-setting of the proteins is associated with the exposure of hydrophobic regions of the proteins resulting in reduced wettability with water and in turn decelerated water uptake.

Dry Foamed Edible Formulation

Protein serves to decrease deformation at break, thereby influencing brittleness and crunchiness. The protein should be thermally denaturable. It cannot be fully denatured. Egg white protein is most preferred. Soy protein or whey protein may also be used. The desired protein concentration in the dry edible formulation is about 42 wt %.

Non-soluble fibre: Non-soluble fibre serves to increase resistance to break, thereby increasing stiffness at higher concentration. Citrus fibre is the preferred non-soluble fibre due to its low aspect ratio. Alternative fibres include carrot fibre, tomato fibre, apple fibre, kiwi fibre, grains and/or leguminoses. Fibre length is an important consideration, since longer fibre reduces crunchiness/brittleness. For example, citrus fibre has a relatively short average length of less than 50 μm. Longer fibre such as oat fibre with lengths above 250 μm result in plastically deforming products rather than brittle products and are therefore less preferred. The desired non-soluble fibre concentration in the dry edible formulation is about 42 wt % but can be altered to tailor the stiffness.

Soluble fibre: Pectin is the preferred soluble fibre. At low concentrations, pectin increases crunchiness and has the opposite effect at higher concentrations. Accordingly the brittleness to stiffness ratio and thereby the extent of crunchiness or crispiness can be adjusted. The applied biting/breaking force has to exceed stiffness in order to start the breakage event. Then the way it breaks described by crunchiness is requiring the multiple cracking on a certain breaking length as provided by the dry foam structure. The desired soluble fibre concentration in the dry edible formulation is about 16 wt %.

Fibre solubility refers to its solubility in water.

Food Product

The dry foamed edible formulation can be used in a food product where crunchiness or crispiness is a desired sensory attribute, such as oil based peanut butter, spreads, creams, chips, apéro sticks, crackers, pretzels, cookies, breakfast cereals, granola, and wafers.

Those skilled in the art will understand that they can freely combine all features of the present invention disclosed herein. In particular, features described for the product of the present invention may be combined with the method of the present invention and vice versa.

Features described for different embodiments of the present invention may be combined. Where known equivalents exist to specific features, such equivalents are incorporated as if specifically referred to in this specification. Further advantages and features of the present invention are apparent from the non-limiting examples.

### EXAMPLES

### Example 1

### Producing Extruded Grissini

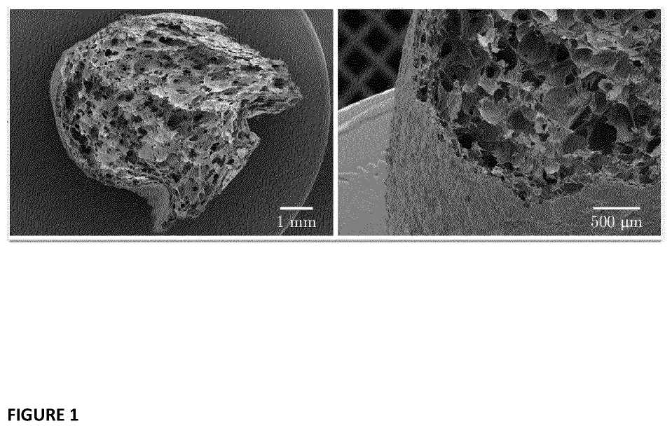

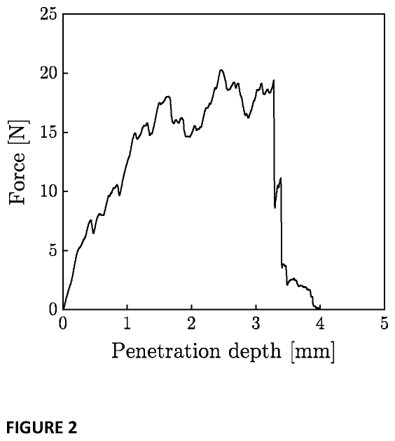

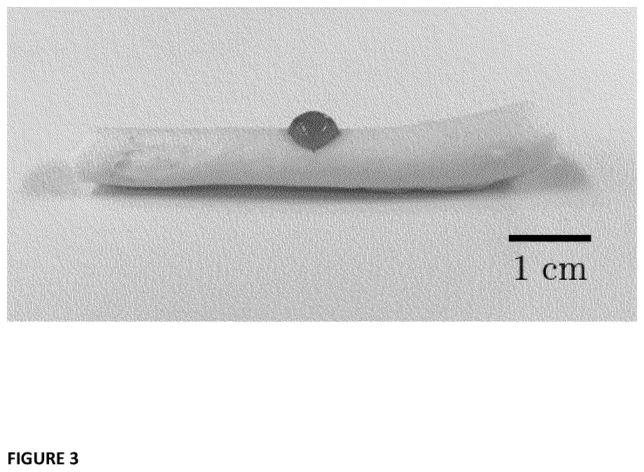

Watery paste of total dry matter of 18 wt % citrus fibre/egg white protein/sugar beet pectin at a weight ratio of 1/1/0.38 was foamed in a twin-screw extruder by dissolving carbon dioxide at a pressure of 15-20 bar followed by pressure release at the extruder exit. The whole extrusion foaming process requires 3.5 min and starts with addition of citrus fibre/egg white protein/sugar beet pectin as dry mix and dosing in of water to form a paste-like mixture. The foam with a gas volume fraction of 55 vol % was extruded onto a Teflon plate as a cylinder with a diameter of 1 cm and a length of 20 cm and dried in a microwave oven at 100° C. hot air and 500 W microwave for 1 min followed by 100° C. hot air and 100 W for 20 min. The dry grissini-like snack has a porous foam structure (FIG. 1) with a closed surface and a density of 120 kg/m³. It also has a crunchy texture. FIG. 2 shows the penetration characteristics of the grissini-like snack upon penetration with a 1 mm thick blade at a velocity of 1 mm/s performed with a texture analyser. The force profile shows several force peaks over the penetration corresponding to several fracture events. It also shows low wettability with water (FIG. 3, water shown as dark spot with food colorant) as the water droplet shows a wetting angle of >>0° C. on the surface of the dry grissini-like structure.

### Example 2

### Comparing Extruded Grissini to Commercial Grissini

A wettability test was performed with an extruded grissini according to the invention as well as grissini from a commercial source (Grissini Torinesi, Roberto). Extruded grissini was made using citrus fibre/egg white protein/sugar beet pectin in the ratio 1/1/0.38 as described in Example 1.

The ingredients of the commercial comparison were wheat flour, olive oil, barley malt, lard, salt, yeast, wheat gluten, peanut oil, antioxidant, rosemary extract. It comprised of 7.7% fat, 74% carbohydrates (3.9% sugar), 2.6% fibre, 11% protein, 2.1% salt.

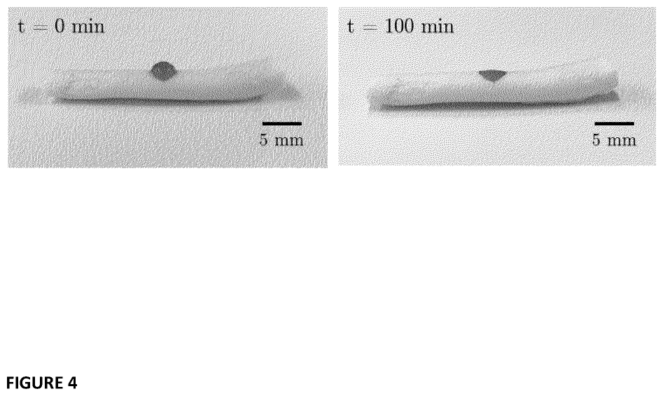

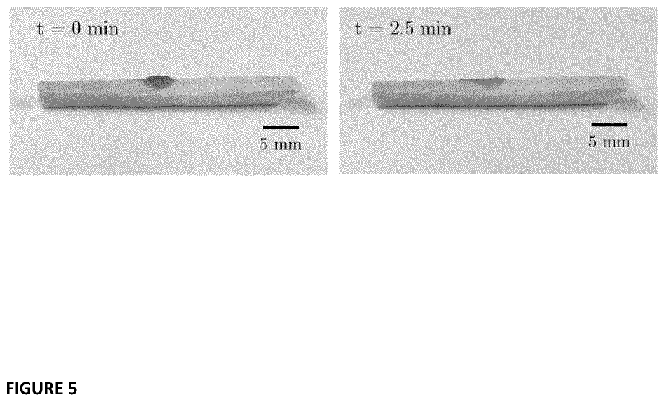

A 150 μl water droplet, colored in blue with food colorant, was placed on the extruded grissini and the commercial grissini. The experiment was performed at 25° C. The water droplet shows a higher contact angle, hence lower wettability on the extruded grissini (FIG. 4), and took about 100 minutes to fully penetrate into the structure), whereas it shows a lower contact angle and thus higher wettability on the commercial grissini (FIG. 5) and took about 2.5 minutes to penetrate into the structure.

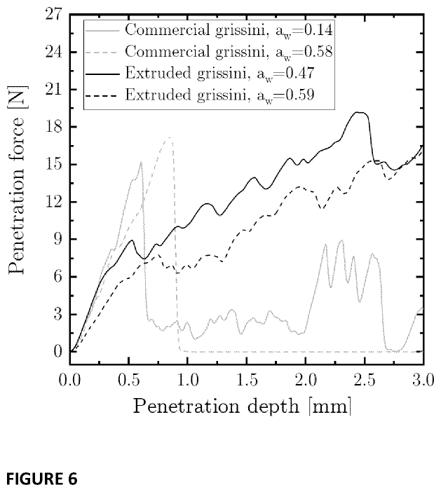

The mechanical properties of both grissinis were compared at different water activities by blade penetration (1 mm thickness) at a velocity of 1 mm/s (FIG. 6). The extruded grissini (made according to Example 1) shows multiple force peaks, hence multiple fracture events, up to a water activity of 0.58, whereas the commercial grissini shows multiple fracture events at a water activity at 0.14 but only one force peak at a water activity of 0.59. This single force peak at high water activity might correspond to the fracturing of the outer thicker crust while the inner porous structure does not seem to show high mechanical resistance.

### Example 3

### Foaming High-Viscous Pastes by Twin-Screw Extrusion

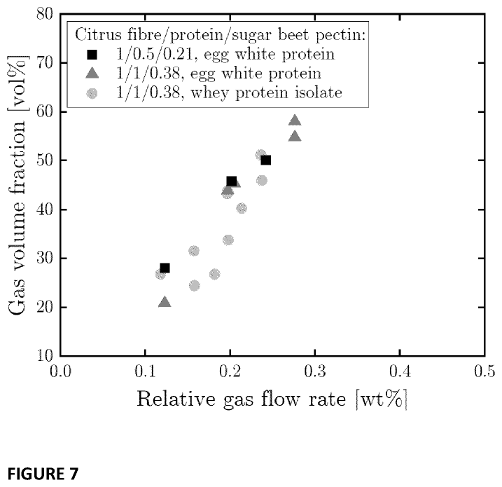

Watery pastes of citrus fibre/protein/sugar beet pectin at different concentrations were foamed by extrusion to generate foams with gas volume fractions between 20 and 60 vol % (FIG. 7). The foamed formulation consisted of (i) 15 wt % citrus fibre/egg white protein/sugar beet pectin at a weight ratio of 1/0.5/0.21, (ii) 18 wt % citrus fibre/egg white protein/sugar beet pectin at a weight ratio of 1/1/0.38, and (iii) 18 wt % citrus fibre/whey protein isolate/sugar beet pectin at a weight ratio of 1/1/0.38. All mixtures showed a zero shear viscosity of 10⁵ Pas. The gas volume fraction was tailored by adjusting the flow rate of gas (carbon dioxide) relative to the flow rate of the paste-like mixture. This allows to generate final products with a broad range of densities after drying.

### Example 4

### Producing Crunchy Particles Foamed with Baking Soda

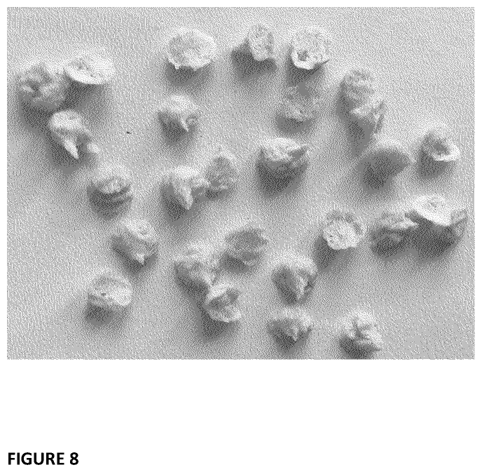

150 g of watery paste with total dry matter of 18 wt % constituted from citrus fibre/whey protein isolate, soy protein isolate or egg white protein/sugar beet pectin at a weight ratio of 1/1/0.38 was mixed with 5 g baking soda as foaming agent powder and shaped into small drops of approximately 5 mm in diameter with an icing bag. The drops were dried at a hot air temperature 100° C. and a microwave power of 350 W for 15 min resulting in dry, porous, crunchy chunks/particles of approximately 4 mm in diameter (FIG. 8)

### Example 5

### Using Mixing to Incorporate Bubbles and Drying in an Oven

1.5 g of WPI (whey protein isolate), 1.5 g of EWP (egg white protein), and 1.5 of citrus fibre were dry mixed. 15.2 g water was added and mixed till a homogeneous paste was formed (total solid content of 23%). During the mixing (with hand mixing or a spoon) air was incorporated resulting in a slightly foamed homogeneous paste. Baking soda can be added to increase air incorporation. The paste was spread out on a baking plate and cut into snacking pieces and dried in an oven at 150° C. for around 20 minutes. The result was a crunchy material. It is possible to add an artificial sweetener, such as allulose, vanilla or chocolate powder to give the final snack food product a certain sweet taste.

### Example 6

### Adding Sugar Beet Pectin to Increase Crunchiness

1.5 g of WPI, 1.5 g of EWP, 1.5 g of citrus fiber and 0.4 g sugar beet pectin were dry mixed. 15.2 g of water was added and mixed till a homogeneous paste was formed (total solid content of 24%). During the mixing step air is incorporated. Air incorporation can be increased by adding baking soda. The resulting paste was heated and dried in a microwave using controlled conditions (50 Watts for more than 1 minute). This resulted in a crunchy material. If using 350 W for 1 minute a dry, however, not crunchy material is obtained. Adding more citrus fibre the foam collapses very quickly during microwave heating and drying

### Example 7

### Adding Another Fibre to the System

1.5 g of WPI, 1.5 g of EWP, and 1.5 of citrus fiber, 7.5 g of chickpea flour and 0.3% baking powder were dry mixed. 18 g of water was added and mixed till a homogeneous paste was formed. The paste was spread out on a baking plate, cut into snacking pieces and dried in an oven at 150° C. for around 20 minutes. The result was a crunchy material. The amount of chickpea flour added can be varied depending on the desired consistency of the paste and thickness of the snacking pieces.

### Example 8

### Using Apple Fibre Instead of Citrus Fibre

3.0 g WPI, 3.0 g EWP, 3 g of Apple fiber, 0.6 g vanilla powder and 0.3% baking soda were dry mixed together. 11 g water was added and mixed till a homogeneous and smooth paste was formed. The paste was spread on a baking plate and dried in an oven at 200° C. for 20 minutes. The obtained dried snacking product had a crunchy texture. An artificial sweetener can be added to create a sweet taste.

### Example 9

### Using Plant Proteins

4.2 g Soy protein isolate (Clarisoy 150), 4.2 g citrus fibre, 1.6% sugar beet pectin and 0.3 g baking powder were dry mixed. 3.6 g of this dry mix was mixed into 16.4 g water. After mixing a homogeneous paste was obtained. The paste had a total solid content of 18 wt %. The paste was spread out on a baking plate and dried in an oven at 200° C. for around 15-20 minutes. The result was a crunchy material.

### Example 10

### Creating a Crunchy Material with a Savory Taste

1.5 g of WPI, 1.5 g of EWP, 1.5 of citrus fiber and 3.6 g tomato puree powder were dry mixed. 11.9 g water was added and mixed till a homogeneous paste was formed. Baking soda can be added to increase air incorporation. The paste was heated and dried in an microwave (50 Watts, 1 minute) or an oven (at 150° C. for around 20 minutes). The result was a crunchy material with a tomato taste. Other savory flavours can be added to create a different savory taste.

### Example 11

### Comparing Foamed Crunchy Biscuit to Commercial Biscuits

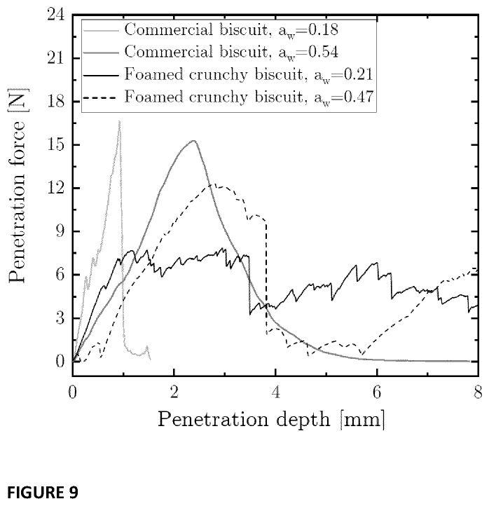

A citrus fibre/egg white protein/sugar beet pectin foam at a weight ratio of 1/0.5/0.21 was produced by foaming a 4.7 wt % egg white protein-sugar beet pectin dispersion in water with a handmixer. Citrus fibre was folded under the foam. Portions of 15 g were placed on a backing tray and dried at 80° C. hot air for 3 hours or until a water content of below 10 wt % was reached. The mechanical properties of these foamed crunchy biscuits were compared to commercial biscuits (Petit Beurre) in a needle penetration test (3 mm needle, velocity of 1 mm/s) at different water activities (FIG. 9). The foamed crunchy biscuit shows multiple force peaks, corresponding to multiple fracture events, at low (0.21) and high (0.47) water activity a_{w}, whereas the commercial biscuit shows several fracture events at low water activity (0.18) but only one force peak at high water activity (0.54). The penetration of the commercial biscuit at high water activity does not lead to emission of sound and was not considered as crunchy or crispy.

The commercial biscuit is composed of half-white flour, sugar, potato starch, butter, sunflower oil, skim milk powder, eggs, salt, baking powder (E503, E500), E330, aroma and contains 10 wt % fat, 77 wt % carbohydrates (24 wt % sugar), 2.2% dietary fibre, 7 wt % protein, and 0.8 wt % salt.

### Example 12

### Producing Crunchy Biscuits Enriched with Nuts

150 g of paste-like mixture with dry content of 30 wt % consisting of whey protein isolate/citrus fibre/ground hazelnuts at a weight ratio of 1/0.4/0.4 was mixed, folded into 50 g of beaten egg white and molded into baking forms with diameter of 5 cm. The biscuits were dried at a hot air temperature 100° C. and a microwave power of 350 W for 15 min resulting in dry, porous, crunchy biscuits of approximately 4 cm in diameter.

1. A method of making an edible formulation, said method comprising the steps:
Preparing a mixture comprising fibre, protein, carbohydrate, and a liquid wherein carbohydrate is present at less than 20 wt %, wherein the mixture is substantially devoid of fat and sugar, and wherein the prepared mixture has a zero shear viscosity greater than 10 Pa·s;
Foaming the mixture to not less than 5 vol % gas fractions; and
Heating and drying the foamed mixture.

2. The method according to claim 1, wherein the non-soluble fibre is a cellulose fibre.

3. The method according to claim 1, wherein the mixture comprises up to 67 wt % protein.

4. The method according to claim 1, wherein the mixture comprises 10-30 wt % solids.

5. The method according to claim 1, wherein the non-soluble fibre and protein are present in a ratio of between about 0.5:1 to about 1:0.5.

6. The method according to claim 1, wherein the protein is a globular protein.

7. The method according to claim 1, wherein the mixture further comprises pectin, preferably sugar beet pectin.

8. The method according to claim 7, wherein the mixture comprises 10-30 wt % non-soluble fibre, protein and pectin in a weight ratio of about 1/1/0.38.

9. The method according to claim 1, wherein the mixture is foamed using an extrusion device.

10. The method according to claim 1, wherein the foamed mixture is heated and dried with hot air and/or microwave power.

11. (canceled)

12. A dry foamed edible formulation comprising non-soluble fibre, protein, carbohydrates, wherein carbohydrate is present at less than 20 wt % and wherein the mixture is devoid of fat and sugar.

13. The foamed edible formulation of claim 12, wherein the formulation
a. shows more than one fracturing event indicated by more than one stress or force peak in mechanical testing such as needle or blade penetration upon a penetration depth of 1 millimeter, preferably 0.2 millimeters; and
b. has a water uptake time of more than 10 minutes.

14. The foamed edible formulation of claim 12, wherein the non-soluble fibre and protein are present in a ratio of about 1:5 to 5:1.

15. The foamed edible formulation of claim 12, further comprising soluble fibre.

16. The foamed edible formulation of claim 12, comprising non-soluble fibre, egg white protein and sugar beet pectin, wherein the non-soluble fibre is citrus fibre.

17. The foamed edible formulation according to claim 16, wherein the citrus fibre, egg white protein and sugar beet pectin in are present in a weight ratio of about 1/1/0.38.

18. (canceled)
